(19) United States
(12) Patent Application Publication
(10) Pub. No.: US 2010/0118350 A1
(43) Pub. Date: May 13, 2010

(54) METHOD OF SEGMENTING A DOCUMENT IMAGE IN DIGITAL IMAGE SCANNING

(75) Inventors: Julia Allwright, Chingford (GB); Roy Gladwin, Buckinghamshire (GB)

Correspondence Address: FAY SHARPE / XEROX - ROCHESTER, 1228 EUCLID AVENUE, 5TH FLOOR, THE HALLE BUILDING, CLEVELAND, OH, 44115, US

(73) Assignee: Xerox Corporation, Norwalk, CT (US)

(21) Appl. No.: 12/269,220

(22) Filed: Nov. 12, 2008

(51) Int. Cl. H04N 1/04

(52) U.S. Cl. 358/402; 358/474; 358/498

(57) ABSTRACT

A method of automatically creating separate images such as PDF or TIFF for selected segments of a scanned document. The user interface enables the user to select the segmenting function and then select the desired segments/pages. The machine automatically creates separate images for each selected segment and sends to a printer or e-mail address.

### BACKGROUND

The present disclosure relates to scanning of documents for creating digital electronic images thereof which are transmitted electronically and which may be submitted to a printing engine for marking on suitable print media. Heretofore, when a user desired to scan a document, and transmit the document electronically, particularly a multi-page document, the portable document format (PDF) generated for the document is a single entity. Where the user wishes to separate or segment specific pages into individual PDF files, it has been necessary to separate the individual pages and separately scan each page to create a separate PDF file for the desired page. Where it is desired to print only a few select pages from a large multi-page document, the manual operation of separating the selected sheets and individually scanning them has been time consuming and costly where large documents are involved and where only a few sheets are desired to be printed from the document.

Accordingly, it has been desired to provide a way or means of creating individual PDF files for selected segments or pages of a multipage document.

### BRIEF DESCRIPTION

The present disclosure describes a way for a user to scan a multi-page document for creating an electronic digital image thereof and to select segments of the document at the user interface whereupon the machine will automatically create a separate digital image such as a PDF file for each segment selected. The method of the present disclosure enables a user to select the desired segments of the document to be scanned at the user input interface and to automatically electronically attach one or more of the segment PDFs to individual e-mail messages for transmission to desired recipients. The method of the present disclosure eliminates the need for a user to manually select segments or pages of a large document for individual scanning where it is desired to print or electronically transmit the selected segments or pages separately from the entire document.

The user interface on the machine may be arranged to enable the user to transmit automatically the selected segment PDFs to any e-mail address chosen by the user. Thus, the user may either transmit the selected segment PDFs to the user's own terminal for subsequently attaching the PDFs to an e-mail message; or, the user interface may be arranged such that the user can automatically e-mail the selected segment PDFs to any chosen e-mail address directly.

### BRIEF DESCRIPTION OF THE DRAWINGS

FIG. 1a is a pictorial plan view of a scanning machine user interface arranged for inputs to employ the present method;

FIG. 1b is a view of an alternative icon or button;

FIG. 2 is a pictorial representation of a graphical user interface (GUI) employed for the method of the present disclosure in selecting the segments to be imaged; and,

FIG. 3 is a block flow diagram of the method of the present disclosure.

### DETAILED DESCRIPTION

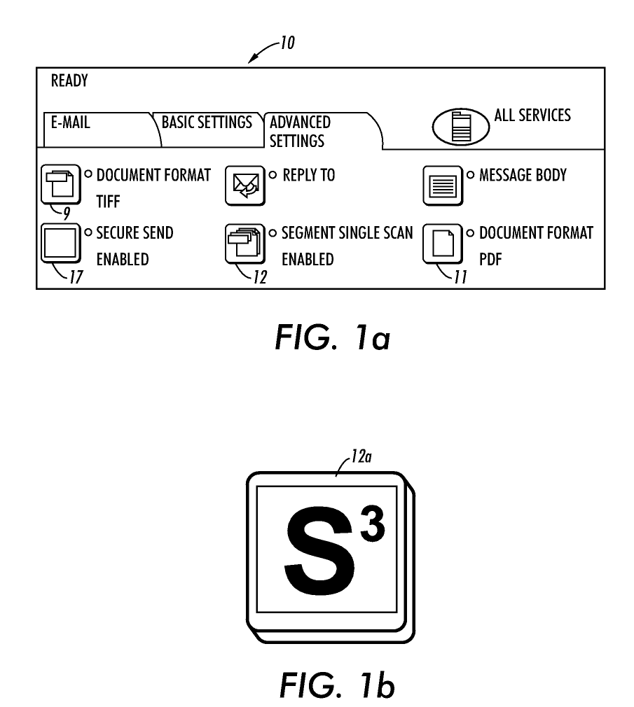

Referring to FIG. 1a, an exemplary user interface for a scanning machine programmed to perform the method of the present disclosure is indicated generally at 10 and has provided thereon a touch screen with a plurality of icons, or alternatively individually push buttons, for user selection of desired functions. In particular, the interface includes icons or buttons 9 operable upon the user selectively touching to select the desired document image type (TIFF or PDF) and an icon or button 12 enable scanning of selected individual segments of a document loaded into a machine for scanning; and, the icon may be arranged to show a pictorial representation of individual pages thereon.

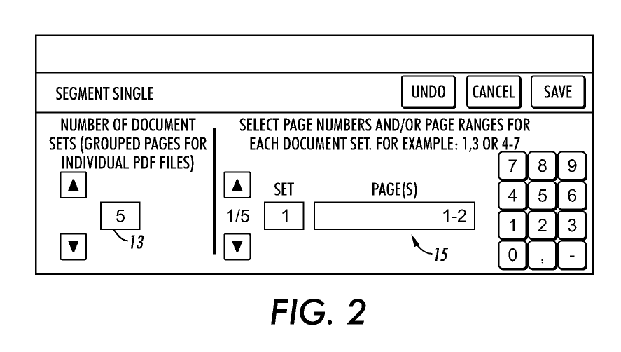

Referring to FIG. 2, upon selection of the function for segmenting the document by activating the touch control 12, the user interface displays the screen shown in FIG. 2. The screen of FIG. 2 may be displayed by changing the screen 10 of FIG. 1a or on a separate screen as part of the user interface. From the display in FIG. 2, the user selects the number of document sets at icon 13 and selects the segments or pages for which is desired to create a single document image or PDF as indicated generally at 15 for subsequent transmission by manually touching the display as indicated for the desired pages.

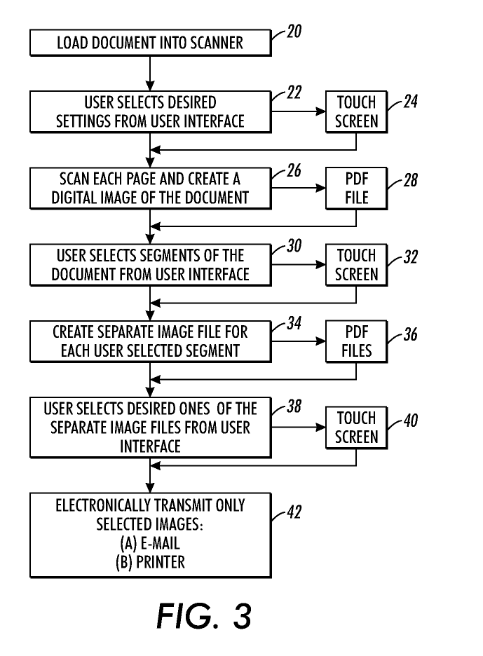

Referring to FIG. 3, the method of the present disclosure is illustrated in block flow diagram wherein the user loads the document into the scanner at step 20 and proceeds to select at the user interface the desired settings at step 22. In the present practice, the selection at step 22 is accomplished via a touch screen at step 24; and, the machine proceeds to scan each page and create a digital image of the loaded document at step 26. In the present practice, the machine produces a PDF file at step 28 and proceeds to step 30 wherein the user selects the desired segments of the document to be imaged individually; and, in the present practice, the selection is accomplished via a touch screen at step 32. The machine then proceeds from step 32 to automatically create a separate image file for each user selected segment at step 34; and, in the present practice, the image file is created as a PDF at step 36.

The user then selects at step 38 the desired ones of these separate image files from the user interface; and, in the present practice, the selection is accomplished via a touch screen at step 40.

The machine then proceeds to step 42 and electronically transmits only the selected images to one or both an e-mail and a printer.

The present disclosure thus describes a way of enabling a user to select segments of a document to be scanned and printed from a user interface and to enable automatic imaging of each of the segments in a separate image such as a PDF file and transmit the selected segment PDF files electronically to one or both an e-mail and a printer.

It will be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

1. A method of segmenting a document image in a digital image scanner: comprising:
(a) scanning each page of the document and creating a digital image of the document;
(b) providing the user with an interface for selectively segmenting the image;
(c) selecting desired segments of the image;
(d) creating a separate image file for each selected segment; and,
(e) selecting desired ones of the image files and electronically transmitting only the selected images.

2. The method defined in claim 1, wherein the step of transmitting includes forwarding to a printing engine.

3. The method defined in claim 1, wherein the step of transmitting includes forwarding as e-mail.

4. The method defined in claim 1, wherein the step of transmitting includes providing a user input at the user interface and automatically e-mailing of the selected images in response to the user input.

5. The method defined in claim 1, wherein the step of creating separate image files for each selected segment includes creating a PDF file.

6. The method defined in claim 1, wherein the step of creating a digital image of the document includes creating a PDF file.

7. A method of digitally scanning a multiple page document comprising:
(a) automatically feeding the pages of the document into the scanner;
(b) automatically scanning each page of the document and creating a PDF file of the document;
(c) providing the user with an interface for segmenting the PDF file and enabling the user to select desired segments of the PDF file;
(d) automatically creating a separate PDF file for each of the selected segments; and,
(e) providing user input controls and enabling the user to select desired ones of the separate PDF files and effect electronic transfer of only the selected desired ones.

8. The method defined in claim 7, wherein the step of providing the user with an interface includes providing a first control element for selecting a segmenting function and providing a second control element for selecting desired segments.

9. The method defined in claim 8, wherein the step of providing a first and second control element includes providing a touch screen.

10. The method defined in claim 9, wherein the step of providing a touch screen includes sequentially providing a first and second touch screen.
